(19) United States
(12) Patent Application Publication
(10) Pub. No.: US 2008/0160970 A1
(43) Pub. Date: Jul. 3, 2008

(54) Method and computer program product for premium mobile service for discovery, payment, personalization and access of mobile content

(75) Inventors: Rajesh Tanamala Srinivas Reddy, Bangalore (IN); Ashok Narasimhan, Los Altos Hills, CA (US); Julian Philips, Bangalore (IN); Vikas Sanathana Murthy, Bangalore (IN); Rishit Jhunjhunwala, Bangalore (IN)

Correspondence Address: William L. Botjer, PO Box 478, Center Moriches, NY, 11934, US

(73) Assignee: JULY SYSTEMS, INC., Santa Clara, CA (US)

(21) Appl. No.: 11/975,520

(22) Filed: Oct. 19, 2007

Related U.S. Application Data
(60) Provisional application No. 60/853,501, filed on Oct. 19, 2006.

(51) Int. Cl. H04M 3/00; H04M 11/00

(52) U.S. Cl. 455/414.1; 455/406; 455/418

(57) ABSTRACT

A method and computer program product for providing mobile content to a user of a mobile device. The mobile content is offered by a mobile content provider. Further, a launcher is provided and is installed on the mobile device. The launcher dynamically provides identity information associated with the user, context information about the user, and a dynamically-defined link to a Wireless Application Protocol (WAP) site of the mobile content provider. Subsequently, the WAP site is displayed when the launcher is activated on the mobile device. The WAP site provides the mobile content offered by the mobile content provider. The display of the WAP site is personalized on the basis of the context information. Thereafter, the purchased mobile content is downloaded by the user of the mobile device.

### RELATED APPLICATION

This application claims priority of U.S. Provisional Patent Application No. 60/853,501 entitled “Premium Mobile Service for Discovery, Payment, Personalization and Access of Mobile Content”, filed on Oct. 19, 2006, which is incorporated by reference as if set forth herein in its entirety.

### BACKGROUND OF THE INVENTION

The invention relates to a method and computer program product for facilitating discovery, purchase, billing, personalization, access and advertising of mobile content at a mobile device such as a mobile phone, PDA computer and the like.

There are two techniques by which a user can discover mobile content offered by a mobile content provider—‘on-deck’ and ‘off-deck’.

In a typical on-deck technique, mobile content is offered through carrier portals. A carrier portal may display mobile content, offered by various mobile content providers, on a predefined number of slots. The mobile content is typically rated, for example, on the basis of their demand. Highly rated mobile content is generally displayed on the available slots in the carrier portal. However, the displayed mobile content is replaced by other mobile content at regular intervals. As the number of slots available on deck is limited, even if mobile content is displayed on a slot, it can be replaced by other mobile content after some time. Further, the mobile content may be rated low and placed below a large number of other mobile content, making it impossible for the user to discover it. Therefore, the on-deck technique does not provide an easy way of discovering the mobile content.

In a typical off-deck technique, the user discovers the mobile content through media advertisements such as print or television (TV) advertisements and promotional websites. The user contacts the mobile content provider, for example, by sending a keyword to a short code. For example, the user may send keyword ‘GET’ to short code ‘12345’. In response, the mobile content provider sends a Short Message Service (SMS) message to the user that contains a link to the Wireless Application Protocol (WAP) site of the mobile content provider. The user's transaction with the mobile content provider is over once the mobile content has been purchased. Therefore, it is difficult for the user to return to the WAP site unless he/she remembers the keyword and the short code or proactively bookmarks the WAP site.

There are various existing techniques for billing a user for the purchase of mobile content. For example, the user may be billed through a credit card system, a debit system such as PayPal, or his/her mobile phone bill. However, entering a credit card number or PayPal account number can be cumbersome and time-consuming. Therefore, the most convenient method for billing the user is to charge the amount directly to his/her mobile phone bill. There are two ways of doing this in the off-deck technique—direct WAP billing and premium SMS billing. Since direct WAP billing requires the approval of associated carriers, it can be very time-consuming or even impossible to receive the necessary approval. In the case of premium SMS billing, the user has to send confirmation SMS messages to complete the purchase. This interrupts the user's purchase experience, making it difficult for him/her to return to the WAP site.

In order to ensure the secure delivery of the purchased mobile content to the user's mobile device, the digital rights are attached to the mobile content. The digital rights attached to the mobile content prevent problems of licensing and copyright violations caused due to the unauthorized access, distribution and usage of the mobile content.

When the purchased mobile content is downloaded on the user's mobile device, the digital rights to the mobile content are also downloaded along with the mobile content. If the user loses the purchased mobile content, he/she also loses the digital rights to the purchased mobile content, and therefore, cannot re-download a working version of the mobile content without re-purchasing the mobile content.

Further, mobile content providers are not able to identify users visiting their WAP sites. Therefore, it is not possible to provide personalized display, content offerings and targeted advertising to the users. The existing off-deck technique does not facilitate targeted display of special offers, features and discounts to specific users.

In light of the above, there is a need for a method and computer program product for providing a quick and convenient way of accessing mobile content. Such a method and computer program product should provide a quick and convenient way of returning to the WAP site after confirmation of the purchase. Further, such a method and computer program product should facilitate personalized display of content and advertising. Moreover, it should provide special offers specific to users.

### SUMMARY OF THE INVENTION

An object of the invention is to provide a method and a computer program product for providing a quick and convenient way of accessing mobile content.

Another object of the invention is to provide a method and a computer program product that facilitates personalized display of content and advertising.

Yet another object of the invention is to provide a method and computer program product for quick and convenient way of returning to the WAP site after confirmation of the purchase.

Yet another object of the invention is to provide a method and computer program product for easily identifying and billing the user of the mobile device.

Still another object of the invention is to provide a method and computer program product for automatically identifying a user of a mobile device based on the identity information of the user.

Still another object of the invention is to provide a method and computer program product for facilitating the user with a one-click access to a WAP site/portal

Yet another object of the invention is to provide a method and computer program product for easily authenticating a user, the user does not have to enter his/her identity details. The identity details include for example login id or password.

Various embodiments of the present invention provide a method and computer program product for providing mobile content to a user of a mobile device. The mobile content is offered by a mobile content provider. Further, a launcher is provided to the user. The launcher is installed on the mobile device. The launcher dynamically provides an identity information associated with the user, context information about the user, and a dynamically-defined link to a Wireless Application Protocol (WAP) site of the mobile content provider. The method further includes displaying the WAP site when the launcher is activated on the mobile device. The WAP site provides the mobile content offered by the mobile content provider. The display of the WAP site is personalized on the basis of the context information and the purchased mobile content is then downloaded by the user of the mobile device. Thereafter, the user's mobile phone is billed based on the identity information of the mobile device.

### BRIEF DESCRIPTION OF THE DRAWINGS

The embodiments of the present invention will hereinafter be described in conjunction with the appended drawings that are provided to illustrate and not to limit the present invention, wherein like designations denote like elements, and in which:

FIG. 1 is an exemplary network, wherein various embodiments of the present invention can be practiced;

FIGS. 2a and 2b are flowcharts illustrating a method for facilitating the discovery, personalized display, purchase, download, and billing of mobile content, in accordance with an embodiment of the present invention;

FIG. 3 is a diagram depicting the steps for downloading the launcher via an SMS message request by a user of a mobile device, in accordance with an embodiment of the present invention;

FIG. 4 is a diagram depicting the steps for downloading the launcher via a WAP portal/site, in accordance with another embodiment of the present invention; and

FIG. 5 illustrates a display screen on the user's mobile device, in accordance with an embodiment of the invention.

### DETAILED DESCRIPTION OF THE INVENTION

Various embodiments of the present invention provide a method and computer program product for providing mobile content to a user of a mobile device. The mobile content is offered by a mobile content provider. Further, a launcher is provided to the user. The launcher is installed on the mobile device. The launcher dynamically provides an identity information associated with the user, context information about the user, and a dynamically-defined link to a Wireless Application Protocol (WAP) site of the mobile content provider. The method further includes displaying the WAP site when the launcher is activated on the mobile device. The WAP site provides the mobile content offered by the mobile content provider. The display of the WAP site is personalized on the basis of the context information and the purchased mobile content is then downloaded by the user of the mobile device. Thereafter, the user's mobile phone may be billed based on the identity information of the mobile device.

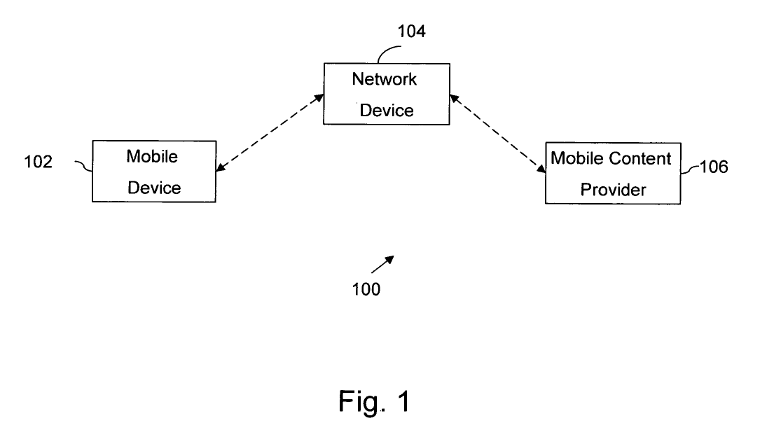

FIG. 1 illustrates an exemplary network 100, in accordance with various embodiments of the present invention. Network 100 includes a mobile device 102, a network device 104, and a mobile content provider 106. Examples of network 100 include, but are not limited to, a Local Area Network (LAN), a Wide Area Network (WAN), a Wireless Fidelity Network (Wi-Fi), a High Performance Radio Local Area Network (HIPERLAN), a Global System for Mobile communications (GSM) network, a Universal Mobile Telecommunications System (UMTS) network, a Public Switched Telephone Network (PSTN), and a General Packet Radio Service (GPRS) network or any other suitable mobile communication network.

Mobile device 102 can be a mobile phone, a smart phone, a Personal Digital Assistant (PDA), or a wired phone. Mobile device 102 can send an SMS message request for mobile content to mobile content provider 106 in network 100. Mobile device 102 can download the requested mobile content from mobile content provider 106. Network device 104 acts as an intermediate device between mobile device 102 and mobile content provider 106. Network device 104 enables the download of the mobile content at mobile device 102 from mobile content provider 104. Examples of network device 104 include, but are not limited to, a Base Transceiver Station (BTS), a Short Message Service Center (SMSC), and a Multimedia Message Service Center (MMSC). Mobile content provider 106 can be a WAP portal, a WAP site, or a WAP server. The method for downloading the mobile content from mobile content provider 106 along with other features has been explained in detail in the subsequent figures.

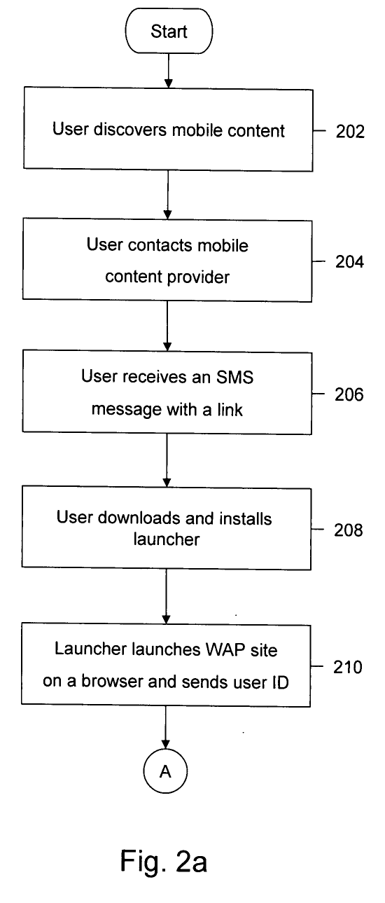

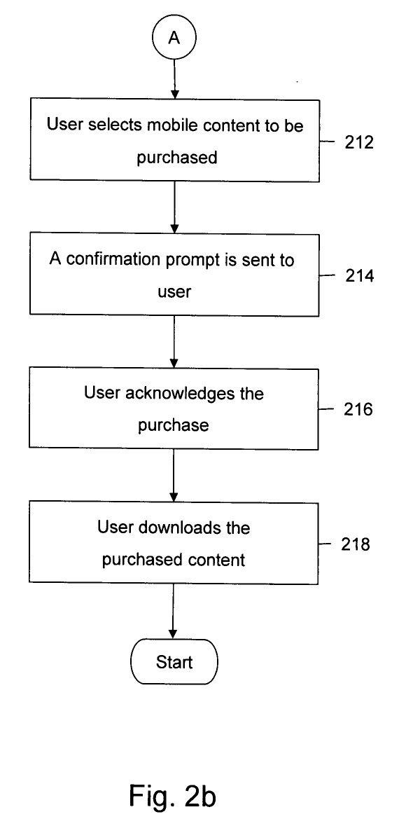

FIGS. 2a and 2b are flow charts illustrating a method for facilitating the discovery, personalized display, purchase, download and billing of mobile content, in accordance with an embodiment of the invention. At step 202, a user discovers the mobile content through media advertisements, for example, print/TV advertisements and promotional websites. Thereafter, at step 204, the user contacts mobile content provider 106 offering the discovered mobile content. For example, the user may send keyword ‘GET’ to short code ‘12345’, in order to contact the mobile content provider. Alternatively, the user may enter the phone number in a promotional website.

Subsequently, at step 206, the user receives an SMS message with a link through which he/she can download a “launcher” to his/her mobile device 102. It should be noted here that the launcher may be made available for download through, for example, affiliate marketing, websites and on-deck links. Next, at step 208, the user downloads and installs the launcher on mobile device 102. Thereafter, the user activates the launcher. The first time the user uses the launcher, he/she is asked to approve the use of his/her identity by the launcher. The user dynamically provides the launcher with identity information associated with the user (e.g., the phone number), context information about the user. For example, the context information about the user can include it's preferences and information about it's previous purchases, and a link to a WAP site of mobile content provider 106.

In accordance with an embodiment of the invention, mobile content provider 106 can load the launcher with the identity information associated with the user (e.g., the phone number), context information about the user (e.g., preferences of the user and information about previous purchases of the user), and a link to a WAP site of mobile content provider 106. The link to the WAP site is defined dynamically by either the user or mobile content provider 106. On activation, at step 210, the launcher launches the WAP site associated with mobile content provider 106 onto a browser on mobile device 102 and sends the user's identity information to the WAP site. The WAP site displays the mobile content offered by mobile content provider 106 as well as the price of the mobile content.

In accordance with an embodiment of the invention, the display of the WAP site is personalized on the basis of the context information about the user.

At step 212, the user selects particular mobile content to be purchased. Subsequently, at step 214, a confirmation prompt is sent to the user to confirm the purchase. At step 216, the user acknowledges the purchase by sending a confirmation SMS message. After sending the acknowledgement, at step 218, the user downloads the purchased mobile content from the link present in the WAP site of mobile content provider 106. This step is facilitated by the launcher, since it includes information about the user and mobile content provider 106. The purchased mobile content along with its digital rights is downloaded from the link present in the WAP site of mobile content provider 106.

In accordance with an embodiment of the invention, once the download is complete, the purchase is charged to the user's mobile phone bill. In accordance with another embodiment of the invention, the user is charged through premium SMS billing, which is initiated by mobile content provider 106 based on the identity information of the user, for example, phone number of the user. The user does not need to initiate the premium SMS billing. In this case, the billing is performed independent of the associated carriers.

In accordance with another embodiment of the invention, the user is charged by a suitable method of billing, which is decided on the basis of the country he/she resides in, the carrier associated with the user, and other factors.

In accordance with yet another embodiment of the invention, the user is charged after he/she acknowledges the purchase. In such a case, the purchase is charged to the user's mobile phone bill even when the user has not downloaded the purchased mobile content to his/her mobile device 102.

In accordance with an embodiment of the invention, the user is sent an SMS message as a reminder, if the user has not downloaded the purchased mobile content within a predefined time period.

Further, the method as described above enables mobile content provider 106 to advertise in between steps 202 and 218. The advertisements can be personalized based on the context information about the user, for example, his/her preferences and the mobile content previously purchased by him/her.

In accordance with an embodiment of the invention, the user may personalize his/her preferences at the WAP site of mobile content provider 106. The context information about the user may be used to recommend the mobile content to the user and to insert appropriate advertisements in-between steps 202 and 218.

Further, the launcher installed on user's mobile device 102, may be configured to wake up automatically on its own or upon receipt of a trigger from mobile content provider 106 to notify purchase benefits to the user. In other words, the launcher can be configured to activate itself and launch a predefined WAP site on a browser. For example, the launcher may be configured to wake up at a predefined date, after a predefined elapsed time, at predefined regular intervals, or upon receipt of a trigger from mobile content provider 106.

Furthermore, the method as described above enables mobile content provider 106 to send alert messages to the user of mobile device 102. The alert messages are sent to the user based on the identity information of the user. In accordance with an embodiment of the invention, mobile cont provider 106 sends the alert messages based on the context information about the user.

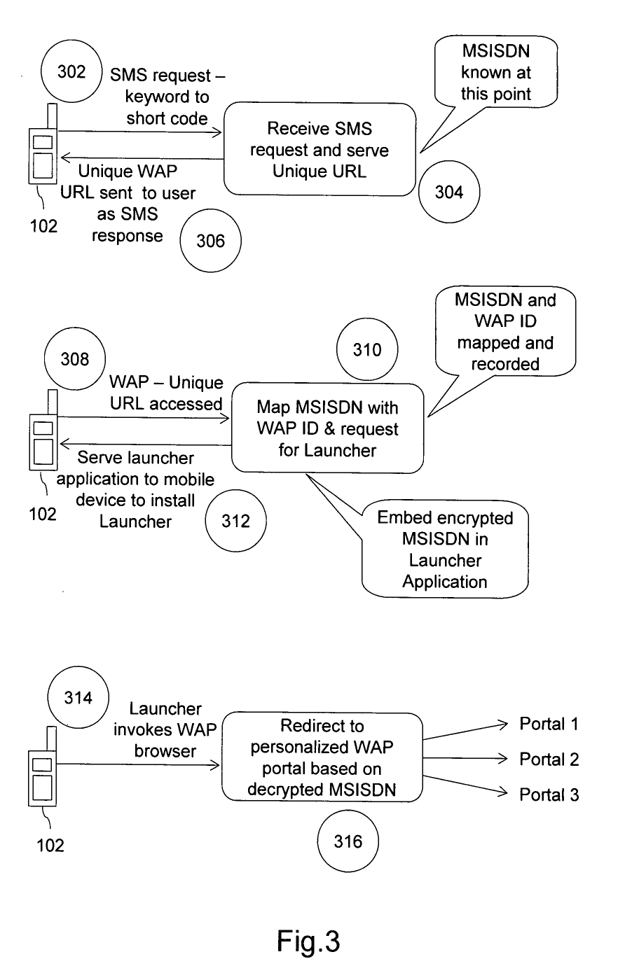

FIG. 3 is a diagram depicting the steps for downloading the launcher via an SMS message request by a user of mobile device 102 (e.g. a mobile phone), in accordance with an embodiment of the invention. At step 302, the user sends an SMS message request containing a keyword to a short code. As mentioned earlier, the user of mobile device 102 may send keyword ‘GET’ to short code ‘12345’, in order to contact mobile content provider 106. At step 304, the SMS message request is received and a unique URL is generated in response to the received SMS message. The Mobile Subscriber Integrated Services Digital Network Number (MSISDN) is determined based on the received SMS message request. The MSISDN is associated with mobile device 102. The MSISDN uniquely identifies a subscription of the mobile device 102 in the network 100 (e.g. a mobile communication network). The MSISDN can be a telephone number to the Subscriber Identity Module (SIM) card in the mobile device 102 (e.g. mobile phone). Examples of the MSISDN are 46701123456789 and 910229328232350. At step 306, the unique URL or link is sent to the user as an SMS message response.

At step 308, the user accesses the unique URL or link received in the SMS message response. At step 310, the MSISDN is mapped with the WAP session ID. The MSISDN and a mobile device ID (e.g. Nokia N 95) are encrypted. The encrypted MSISDN is embedded in a launcher application. For example, the launcher application can be a Launcher Java Application Descriptor (JAD) file or a Launcher Java Archive (JAR) file. The implementation of the launcher application will be appreciated by a person of ordinary skill in the art. The launcher application is specific to the mobile device ID (e.g. a JAD application specific to Nokia N 95). At step 312, the launcher application is served to the user to install the launcher at user's mobile device 102. The user installs the launcher at his/her mobile device 102 using the received launcher application.

In accordance with an embodiment of the invention, a mobile device ID (e.g. Nokia N 95) and MSISDN is sent to a third party system. The MSISDN is encrypted and embedded in a launcher application by the third party system. Subsequently, the third party system serves the launcher application to the user to install the launcher at user's mobile device 102.

At step 312, the launcher at mobile device 102 invokes a WAP browser. At step 314, the user of mobile device 102 is redirected to the personalized WAP portal based on the decrypted MSISDN.

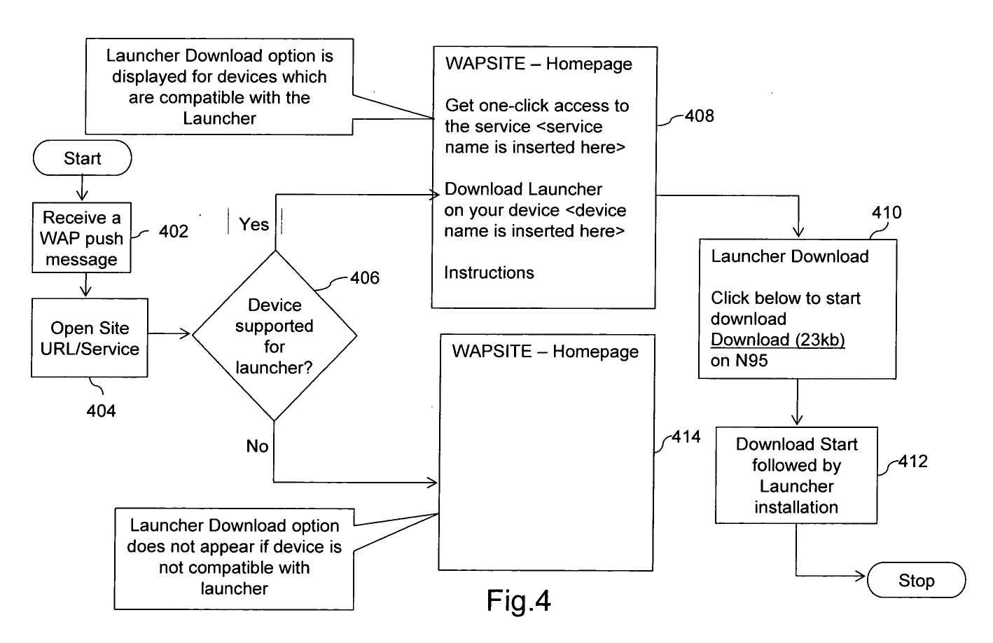

FIG. 4 is a diagram depicting the steps for downloading the launcher via a WAP portal/site, in accordance with an embodiment of the invention. At step 402, the user receives a WAP push message at mobile device 102. At step 404, the user opens the WAP site using a link or a URL received in the WAP push message. At step 406, it is checked whether mobile device 102 is compatible with the launcher application. If mobile device 102 is compatible with the launcher application, then at step 406, the user is presented a WAP site page with a link to download the launcher. The displayed WAP site page also includes instructions for downloading the launcher. For example, the instruction can be ‘Click on the Download Launcher’. The user then inserts the service name and the mobile device name (e.g. name of mobile device 102) in the presented WAP site home page. The user who is presented with the launcher download link can select the link and proceed to download the launcher by following the instructions on the page. At step 410, the user is presented with a WAP site page containing the mobile device specific launcher download link and the instructions to download the mobile device specific launcher. Thereafter, the user selects the launcher download link. At step 412, the download of the launcher starts. The launcher is installed at mobile device 102 after the complete download of the launcher at mobile device 102.

However, if at step 406, mobile device 102 is not compatible with the launcher application, then step 414 is executed. At step 414, a WAP site home page without the launcher download link is presented to the user. In such a case, the user will not be able to download the launcher application on his/her mobile device 102.

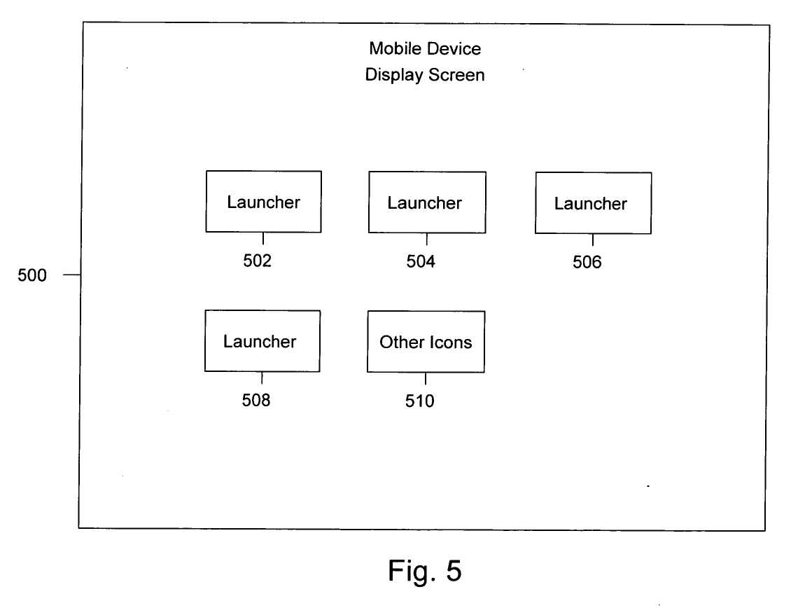

FIG. 5 illustrates a display screen 500 on user's mobile device 102, in accordance with an embodiment of the invention. Display screen 500 displays a launcher 502, a launcher 504, a launcher 506, a launcher D 508, and other icons 510 related to applications in user's mobile device 102. Launcher 502, launcher 504, launcher 506 and launcher 508 are installed on user's mobile device 102, and are, therefore, available to the user to connect to corresponding WAP sites at any time (step 110 in FIG. 1a). The user may, for example, configure launcher 502 to wake up at a predefined time or upon receipt of a trigger from mobile content provider 106.

Various embodiments of the invention facilitate a method and a computer program product for quick and convenient discovery of mobile content as the user can return to mobile content provider through the launcher.

Various embodiments of the invention provide a method and a computer program product for an easy way for billing the purchase to the user's mobile phone bill as the user can return to the WAP site through the launcher.

Further, various embodiments of the invention provide a carrier-independent and a service provider-independent method and computer program product for accessing the WAP site. For example, different service providers of different countries operate and serve users using different operating rules and service features. The invention provides a method and computer program product which is globally compatible with all service providers and carriers. Also, the method described above is used for accessing WAP site using services of any service provider in any country.

In addition, billing of purchases made by the user is also carrier-independent. Furthermore, the mobile content provider is able to maintain a long-term relationship with the user, as the launcher stays on the user's mobile device and includes user identification. The user can return to the WAP site of the mobile content provider whenever he/she desires.

Further, various embodiments of the invention facilitate automatic or triggered activation of the launcher and communication to the mobile content provider, which enables the mobile content provider to promote purchase benefits such as additional offers, features, and special discounts. In addition, the transfer of user identification to the WAP site facilitates personalization of, for example, the WAP site display, content offerings, and advertisements.

Furthermore, various embodiments of the invention facilitates automatic authentication of the user. The user does not need to enter identity information. Examples of the identity information include login id or password of the user.

In addition, various embodiments of the invention facilitate unique identification of each user visiting the WAP site based on the identity information of each user.

The method, as described in the present invention or any of its components, may be embodied in the form of a computer program being run in a computer system. Typical examples of a computer system include a general-purpose computer, a programmed microprocessor, a micro-controller, a peripheral integrated circuit element, and other devices or arrangements of devices that are capable of implementing the steps constituting the method of the present invention. The computer may also be a part of the mobile device.

The computer system comprises a computer, an input device, a display unit and the Internet. The computer comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions into the computer system.

The computer system executes a set of instructions that are stored in one or more storage elements, to process input data. The storage elements may also hold data or other information, as desired. The storage elements may be an information source or physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program, or a portion of a program module. The software might also include modular programming in the form of object-oriented programming. Processing of input data by the processing machine may be in response to user commands, to the results of previous processing, or to a request made by another processing machine.

While various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for providing mobile content to a user, the mobile content being offered by a mobile content provider, the user being associated with a mobile device, the method comprising the steps of:
a. providing a launcher to the user, the launcher being installed on the user's mobile device, the launcher dynamically provides identity information associated with the user, context information about the user, and a dynamically-defined link to a Wireless Application Protocol (WAP) site of the mobile content provider;
b. displaying the WAP site when the launcher is activated on the user's mobile device, the WAP site providing the mobile content offered by the mobile content provider, wherein the display of the WAP site is personalized on the basis of the context information about the user; and
c. downloading the mobile content purchased by the user.

2. The method according to claim 1, wherein the context information about the user comprises at least one of: preferences of the user and information about previous purchases made by the user.

3. The method according to claim 1, wherein the step of providing the launcher further comprises the steps of:
a. sending a link to the user for downloading the launcher;
b. downloading the launcher on the user's mobile device, wherein the user downloads the launcher from the sent link; and
c. installing the launcher on the user's mobile device.

4. The method according to claim 1 further comprising the steps of:
a. receiving a purchase request for a mobile content from the user;
b. prompting the user to confirm the purchase request; and
c. providing the purchased mobile content for download.

5. The method according to claim 1 further comprising the step of billing charges to the user's mobile phone bill, wherein the mobile content provider uses the identity information associated with the user for initiating premium Short Message Service (SMS) billing.

6. The method according to claim 4, wherein the purchased mobile content is downloaded by the user, along with digital rights associated with the purchased mobile content.

7. The method according to claim 1, wherein the launcher is configured to wake up and launch the WAP site automatically as desired by the user.

8. The method according to claim 1, wherein the launcher is configured to wake up and launch the WAP site, upon receipt of a trigger from the mobile content provider, the launched WAP site notifying purchase benefits to the user.

9. The method according to claim 1 further comprising the step of inserting advertisements, the advertisements being personalized on the basis of the context information about the user.

10. The method according to claim 1 further comprising the step of sending alert messages to the mobile device of the user based on the identity information of the user.

11. The method according to claim 1 further including the step of providing the user with a one-click access to the WAP site.

12. The method according to claim 1 further including the step of providing creating a brand presence of the launcher on the mobile device's main menu.

13. The method according to claim 1 further including the step of providing a unique identification of each user visiting the WAP site based on the identity information of the user.

14. The method according to claim 1 further including the step of providing personalization of the WAP site content separately for each user based on the identity information of the user.

15. The method according to claim 1 further including the step of providing a carrier-independent means for accessing the WAP site.

16. The method according to claim 1 further including the step of providing automatic authentication of the user of the mobile device, the user does not need to enter the identity information.

17. A computer program product for use with a computer, the computer program product comprising a computer usable medium having a computer readable program code embodied therein for providing mobile content to a user, the mobile content being offered by a mobile content provider, the user being associated with a mobile device, the computer program product performing:
a. providing a launcher to the user, the launcher being installed on the user's mobile device, the launcher dynamically provides identity information associated with the user, context information about the user, and a dynamically-defined link to a Wireless Application Protocol (WAP) site of the mobile content provider;
b. displaying the WAP site when the launcher is activated on the user's mobile device, the WAP site providing the mobile content offered by the mobile content provider, wherein the display of the WAP site is personalized on the basis of the context information about the user; and
c. downloading the mobile content purchased by the user.
